(19) United States
(12) Patent Application Publication
(10) Pub. No.: US 2021/0369534 A1
(43) Pub. Date: Dec. 2, 2021

(54) ASSIST DEVICE

(71) Applicant: JTEKT CORPORATION, Osaka-shi (JP)

(72) Inventors: Yuki KOBAYASHI, Nara-shi (JP); Mitsuharu OZAKI, Kashiba-shi (JP); Hiromichi OHTA, Kariya-shi (JP); Madoka HATTORI, Nara-shi (JP)

(73) Assignee: JTEKT CORPORATION, Osaka-shi (JP)

(21) Appl. No.: 17/329,328

(22) Filed: May 25, 2021

(30) Foreign Application Priority Data
May 27, 2020 (JP) 2020-092534

(51) Int. Cl. A61H 1/02; B25J 9/00

(52) U.S. Cl. CPC A61H 1/0244; A61H 2201/1671; A61H 2201/165; B25J 9/0006

(57) ABSTRACT

An assist device includes an actuator; a first body-worn unit including a belt body; right and left arms; and second body-worn units that are attached to distal parts of the arms and worn on thighs of the user. The belt body includes an upper belt and a lower belt provided on a back side of the user, the upper belt and the lower belt respectively extending along an upper side and a lower side of buttocks of the user. The assist device includes a restraining belt that connects the second body-worn units to the lower belt and restrains the lower belt from moving upward.

### CROSS-REFERENCE TO RELATED APPLICATION

This application claims priority to Japanese Patent Application No. 2020-092534 filed on May 27, 2020, incorporated herein by reference in its entirety.

### BACKGROUND

### 1. Technical Field

This disclosure relates to an assist device.

### 2. Description of Related Art

Various assist devices that are worn on the bodies of users (persons) to assist the users in tasks have been proposed. When lifting a heavy object, for example, a user of an assist device can perform the task with a smaller force (with less burden). Such an assist device is disclosed, for example, in Japanese Patent Application Publication No. 2018-199205 (JP 2018-199205 A).

### SUMMARY

The assist device disclosed in JP 2018-199205 A includes a frame made of metal etc. that is worn by a user. An output of an actuator installed in this frame is transmitted to the upper body and the lower body of the user through a link mechanism. This assists the user, for example, in an action of lifting a heavy object.

The applicant of the disclosure to be disclosed herein has proposed an assist device that is made more lightweight and compact (e.g., Japanese Patent Application No. 2018-230920). As shown in FIG. 9, this assist device includes an actuator 90 including right and left activation units 91 that generate torque around an imaginary line Li passing through the hips BW of a user in a right-left direction; a first body-worn unit 92 with which the actuator 90 is worn on the body of the user; right and left arms 93 that are swung by the torque; and second body-worn units 94 that are attached to the distal parts of the arms 93 and worn on the thighs BF of the user. The first body-worn unit 92 includes a belt body 95 that connects the right and left activation units 91 to each other.

The belt body 95 includes an upper belt 97 and a lower belt 98 that are provided on the back side of the user, in addition to a front belt 96 that is provided to extend along the abdomen of the user. The upper belt 97 is located along the upper side of the buttocks of the user, and the lower belt 98 is located along the lower side of the buttocks of the user. By being located on both sides of the buttocks in the up-down direction, the upper belt 97 and the lower belt 98, which work in conjunction with the front belt 96, can bring the belt body 95 into close contact with the user. The belt body 95 stabilizes the right and left activation units 91, and thus, a desired assist force can be provided to the user with the use of the torque generated by the activation units 91.

When, for example, to lift a load or put a load down, the user wearing the assist device as described above performs an action involving bending and stretching his or her legs that are placed about shoulder-width apart, the lower belt 98 is kept in a state in which the lower belt 98 extends along the lower side of the buttocks. However, when the user performs an action of crouching down with his or her legs more than shoulder-width apart in the right-left direction, the lower belt 98 that has been located along the lower side of his or her buttocks may become displaced upward. Then, when the user performs another action from the crouching state to perform a task, the activation units 91 are not stabilized relatively to the hips BW of the user and may fail to provide the user with a desired assist force.

The disclosure provides an assist device that can restrict the displacement of a belt body and provide a user with a desired assist force.

An assist device according to one aspect of the disclosure includes an actuator including right and left activation units that are configured to generate torque around an imaginary line passing through hips of a user in a right-left direction; a first body-worn unit including a belt body that connects the right and left activation units to each other, the actuator being worn on a body of the user with use of the first body-worn unit; right and left arms that are swung by the torque; and second body-worn units that are attached to distal parts of the arms and worn on thighs of the user. The belt body includes an upper belt and a lower belt provided on a back side of the user, the upper belt and the lower belt respectively extending along an upper side and a lower side of buttocks of the user. The assist device includes a restraining belt that connects the second body-worn units to the lower belt and restrains the lower belt from moving upward.

This assist device can restrict the upward displacement of the lower belt of the belt body even when, for example, the user assumes a posture of hunkering down. As a result, an assist force of the assist device can be appropriately provided to the user. Thus, it is possible to restrict the displacement of the belt body and to provide the user with a desired assist force regardless of the posture of the user.

The restraining belt may include a left restraining belt that connects a left second body-worn unit of the second body-worn units to the lower belt, and a right restraining belt that connects a right second body-worn unit of the second body-worn units to the lower belt, the left second body-worn unit being worn on the thigh of a left leg of the user, and the right second body-worn unit being worn on the thigh of a right leg of the user. In this case, the left restraining belt and the right restraining belt function independently of each other when the user assumes a posture in which his or her right and left legs are bent differently from each other. This can enhance the function of restricting the upward displacement of the lower belt.

The lower belt can shift in the up-down direction most freely at its center in the right-left direction. In the case where the restraining belt includes the left restraining belt and the right restraining belt as described above, the left restraining belt may include an inclination part that extends from the left second body-worn unit toward the lower belt so as to incline toward a center in the right-left direction; and the right restraining belt may include an inclination part that extends from the right second body-worn unit toward the lower belt so as to incline toward the center in the right-left direction. In this configuration, the left restraining belt and the right restraining belt are connected to the lower belt, at positions closer to the center of the lower belt. This can further enhance the function of restricting the displacement of the lower belt.

As another form of the restraining belt, the restraining belt may include a common belt part that is connected to a central part of the lower belt in the right-left direction; a left belt part that is connected to a left second body-worn unit of the second body-worn units, the left second body-worn unit being worn on the thigh of a left leg of the user; a right belt part that is connected to a right second body-worn unit of the second body-worn units, the right second body-worn unit being worn on the thigh of a right leg of the user; and a coupling part that couples the left belt part and the right belt part to the common belt part. The lower belt can shift in the up-down direction most freely at its center in the right-left direction. In this configuration, therefore, the common belt part is connected to the central part of the lower belt, which can further enhance the function of restricting the displacement of the lower belt.

In the case where the restraining belt includes the common belt part, the left belt part and the right belt part may be continuous with each other; and the coupling part may support a continuous part including the left belt part and the right belt part that are continuous with each other in a state in which the continuous part is folded back at an intermediate point, so as to allow the continuous part to move in a longitudinal direction of the continuous part. In this configuration, the length of each of the left belt part and the right belt part can vary freely when the user assumes a posture in which his or her right and left legs are bent differently from each other. This can further enhance the function of restricting the displacement of the lower belt.

The restraining belt may include an elastic part that is stretchable and shrinkable, the elastic part being provided in at least a part of the restraining belt. In this configuration, the length of the restraining belt can vary, and thus, the restraining belt can adapt easily to a change in posture of the user to increase the comfort of wearing. In addition, this restraining belt does not hinder a walking motion of the user.

The assist device disclosed herein can restrict the displacement of the belt body and provide the user with a desired assist force.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing the overall configuration of one example of an assist device;

FIG. 2 is an exploded perspective view of the assist device shown in FIG. 1;

FIG. 3 is a side view showing a user wearing the assist device shown in FIG. 1;

FIG. 4 is a side view showing the user wearing the assist device shown in FIG. 1;

FIG. 5 is a back view showing a schematic configuration of the assist device;

FIG. 6 is a back view showing a modified example of restraining belts;

FIG. 7 is a back view showing a modified example of the restraining belts;

FIG. 8 is a perspective view showing a modified example of the assist device; and

FIG. 9 is a view illustrating the assist device that has been already proposed.

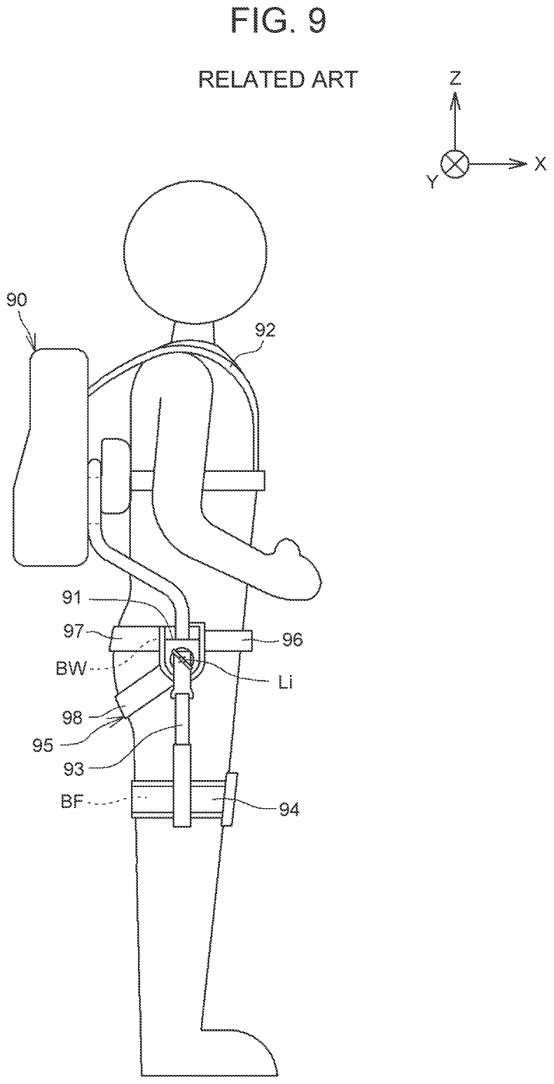

### DETAILED DESCRIPTION OF EMBODIMENTS

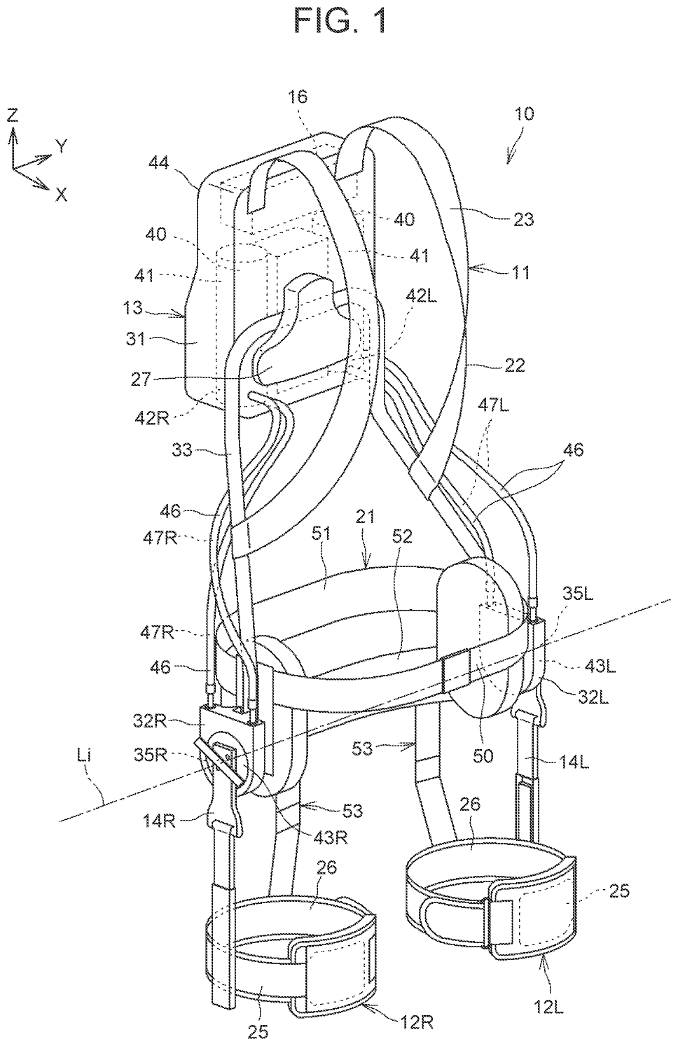

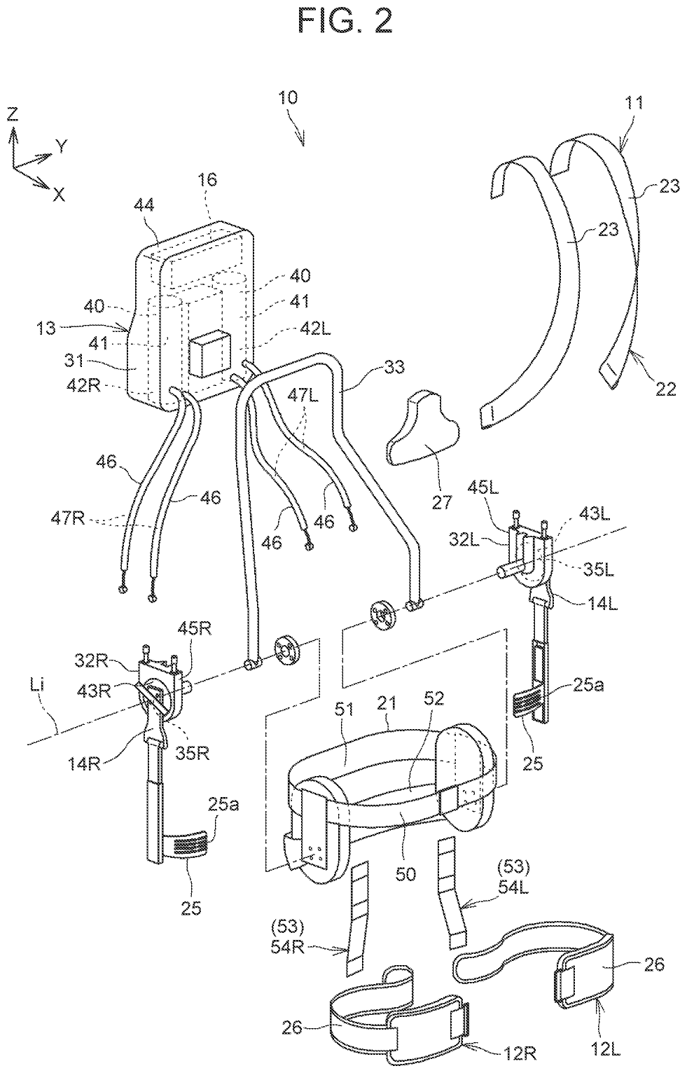

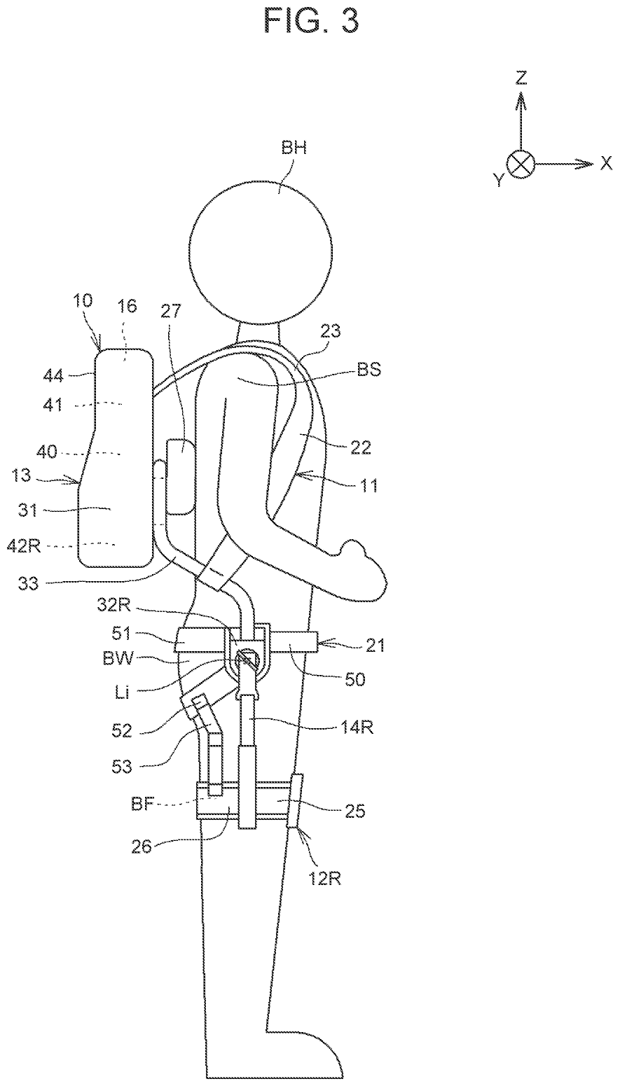

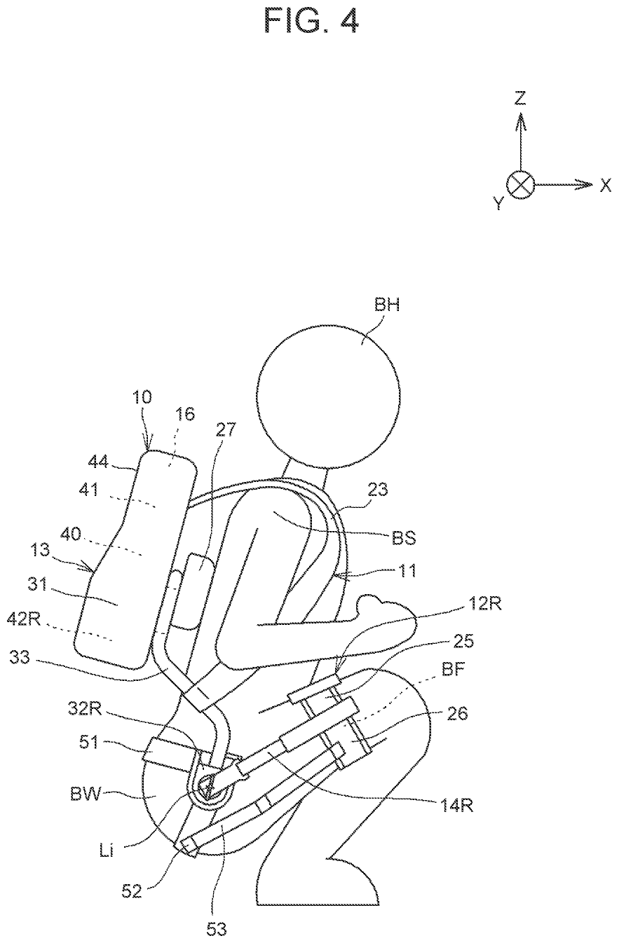

FIG. 1 is a perspective view showing an overall configuration of one example of an assist device. FIG. 2 is an exploded perspective view of the assist device shown in FIG. 1. FIG. 3 and FIG. 4 are side views showing a user wearing the assist device shown in FIG. 1. In FIG. 3, the user is in an upright standing posture, and in FIG. 4, the user is in a posture of hunkering down with his or her hips BW considerably lowered. The upright standing posture shown in FIG. 3 is a posture in which a longitudinal direction of the upper body of the user from the hips BW toward the head BH lies along a vertical line.

The assist device 10 is a device that assists the user in turning his or her legs (thighs BF) relatively to his or her hips BW when the user lifts a load or puts a load down, and assists the user in turning his or her legs (thighs BF) relatively to his or her hips BW when the user walks. An operation of the assist device 10 giving physical assistance to the user will be referred to as an “assist operation.”

The X-axis, Y-axis, and Z-axis in the drawings are orthogonal to one another, and with respect to a user who is wearing the assist device 10 and in an upright standing posture, an X-axis direction, a Y-axis direction, and a Z-axis direction correspond to a frontward direction, a leftward direction, and an upward direction, respectively. As far as the assist operation is concerned, assisting the legs (thighs BF) to turn relatively to the hips BW is the same as assisting the hips BW to turn relatively to the legs (thighs BF). The assist operation is an assist operation of providing the user with torque around an imaginary line Li that passes through the hips BW of the user in a right-left direction of the user. This torque will be also referred to as “assist torque.”

The assist device 10 shown in FIG. 1 includes a first body-worn unit 11, right and left second body-worn units 12R, 12L, an actuator 13, and right and left arms 14R, 14L.

The actuator 13 of this embodiment includes one driving source unit 31, right and left activation units 32R, 32L, and a frame 33. The frame 33 is formed by, for example, a high-rigidity member such as a metal member, and couples the driving source unit 31 and the right and left activation units 32R, 32L together. The driving source unit 31 and the right and left activation units 32R, 32L are integrated by the frame 33. The actuator 13 generates torque around the imaginary line Li. This torque causes the right and left arms 14R, 14L to swing in a front-rear direction around the imaginary line Li. The specific configuration for the actuator 13 to swing the arms 14R, 14L will be described later.

The first body-worn unit 11 is a member which includes a belt body 21 for the hips BW of the user and a jacket 22 for the shoulders BS of the user and by which the actuator 13 is worn on the body of the user. The first body-worn unit 11 further includes a backrest cushion 27. The backrest cushion 27 is interposed between the driving source unit 31 and the back of the user.

The belt body 21 is worn around the hips BW of the user, particularly around the abdomen and the buttocks of the user. The belt body 21 is formed by a flexible member, such as a fabric or leather member. The belt body 21 may include a hard core, such as a resin core, as a part thereof. The belt body 21 is configured such that the length thereof around the hips BW can be changed, and the belt body 21 is thereby brought into close contact with the abdomen and the buttocks. The right and left activation units 32R, 32L are attached to the belt body 21. The jacket 22 includes shoulder belts 23 that are worn on the shoulders BS of the user. The shoulder belts 23 are attached, for example, to the driving source unit 31 and the frame 33. The shoulder belts 23 are formed by a flexible member, such as a fabric or leather member. The user can carry the driving source unit 31 on his or her back with the use of the shoulder belts 23, and wear the activation units 32R, 32L on right and left sides of his or her hips BW with the use of the belt body 21.

The right and left second body-worn units 12R, 12L are worn on the thighs BF of the right and left legs of the user. The second body-worn unit 12L for the left thigh BF and the second body-worn unit 12R for the right thigh BF have shapes reversed from each other in the right-left direction, but have the same configuration. As shown in FIG. 2, the second body-worn unit 12R (12L) includes a main part 25 that is formed by a hard core, such as a metal or resin core, and a band member 26 that is formed by a flexible member, such as a fabric or leather member. The main part 25 is coupled to a distal part of the arm 14R (14L). The main part 25 includes a pad 25a that comes into contact with a front side of the thigh BF. The band member 26 is attached to the main part 25 and used to fix the main part 25 to the thigh BF. At least a part of the band member 26 is elastically deformable, and the length of the second body-worn unit 12R (12L) around the thigh BF can be changed. The band member 26 includes a touch-and-close fastener (i.e., a hook-and-loop fastener), for example, and is fixed in a state of being wrapped around the thigh BF. Thus, the second body-worn unit 12R (12L) is worn so as not to become displaced relatively to the thigh BF.

As described above, the actuator 13 includes the one driving source unit 31, the right and left activation units 32R, 32L, and the frame 33. The driving source unit 31 is carried on the back of the user with the use of the first body-worn unit 11. The right and left activation units 32R, 32L are worn on the right and left sides of the hips BW of the user with the use of the belt body 21. The left activation unit 32L and the right activation unit 32R have shapes reversed from each other in the right-left direction, but have the same configuration and the same function. The left activation unit 32L and the right activation unit 32R can operate independently of each other, and can perform different operations as well as perform the same operation synchronously. The assist device 10 assists the user in turning his or her thighs BF relatively to his or her hips BW with the use of torque (assist torque) output by the right and left activation units 32R, 32L. In the following, the specific configuration of the actuator 13 will be described.

The driving source unit 31 includes motors 40, speed reducers 41 that reduce the speed of rotation of the motors 40, right and left driving pulleys 42R, 42L that are rotated by outputs of the speed reducers 41, and a case 44 that is fixed to the frame 33. The motors 40, the speed reducers 41, and the driving pulleys 42R, 42L are provided inside the case 44. The motor 40 and the speed reducer 41 for the left driving pulley 42L and the motor 40 and the speed reducer 41 for the right driving pulley 42R are provided, and the right and left driving pulleys 42R, 42L can rotate independently of each other. A battery that supplies electricity to the motors 40 etc. is also housed inside the case 44.

The right activation unit 32R includes a case 45R fixed to the frame 33, a driven pulley 43R provided inside the case 45R, and an output shaft 35R attached to the driven pulley 43R. The left activation unit 32L includes a case 45L fixed to the frame 33, a driven pulley 43L provided inside the case 45L, and an output shaft 35L attached to the driven pulley 43L. Each of the right and left driven pulleys 43R, 43L is provided so as to be able to turn in one direction and the other direction around the imaginary line Li passing through the hips BW of the user in the right-left direction.

Wires 47R are wound around the driving pulley 42R and the driven pulley 43R on the right side of the actuator 13. Wires 47L are wound around the driving pulley 42L and the driven pulley 43L on the left side of the actuator 13. The wires 47R, 47L are respectively housed in guides 46 that are provided between the driving source unit 31 and the right and left activation units 32R, 32L. The guides 46 and the frame 33 may be an integral structure.

When the motors 40 turn the right and left driving pulleys 42R, 42L in the one direction, the right and left driven pulleys 43R, 43L turn in the one direction with the wires 47R, 47L functioning as power transmission members. When the motors 40 turn the driving pulleys 42R, 42L in the other direction, the driven pulleys 43R, 43L turn in the other direction with the wires 47R, 47L functioning as power transmission members. The output shaft 35L is coaxially attached to the left driven pulley 43L, and the driven pulley 43L and the output shaft 35L rotate integrally. The output shaft 35R is coaxially attached to the right driven pulley 43R, and the driven pulley 43R and the output shaft 35R rotate integrally. The output shafts 35R, 35L are shafts centered on the imaginary line Li.

A base part of the right arm 14R is attached to the right output shaft 35R, and the output shaft 35R and the arm 14R move integrally. A base part of the left arm 14L is attached to the left output shaft 35L, and the output shaft 35L and the arm 14L move integrally. The second body-worn units 12R, 12L are attached to the distal parts of the arms 14R, 14L, respectively. As the output shafts 35R, 35L rotate, torque that causes the right and left arms 14R, 14L to swing around the imaginary line Li is provided to the user as assist torque.

Thus, the driving source unit 31 and the activation units 32R, 32L integrated by the frame 33 are worn on the upper body of the user with the use of the first body-worn unit 11, and the second body-worn units 12R, 12L fixed to the arms 14R, 14L are worn on the thighs BF of the user. Based on rotation of the motors 40, the angles between the driving source unit 31 and the activation units 32R, 32L on one side and the arms 14R, 14L on the other side around the imaginary line Li are changed. The assist operation of providing the user with an assist force through the first body-worn unit 11 and the second body-worn units 12R, 12L is performed by the actuator 13 including the driving source unit 31 and the activation units 32R, 32L configured as has been described. For example, when the user changes his or her posture from a sitting, forward leaning posture (see FIG. 4) to an upright standing posture (see FIG. 3) to lift a heavy object, this change in posture is made easy by the assist torque.

The assist device 10 further includes a controller 16 inside the case 44. The controller 16 includes a processing part including a central processing unit (CPU), a storage device formed by a non-volatile memory or the like that stores information, such as various programs and databases, and a motor driver. The processing part obtains an assist parameter (assist torque) of the assist operation. The motor driver causes the actuator 13 (motors 40) to operate based on a signal according to the assist parameter (assist torque). The assist torque obtained by the processing part is, for example, torque that causes the output shafts 35R, 35L to rotate.

The assist device 10 further includes an operation unit (not shown). The operation unit is a so-called remote controller, and is a device by which the user inputs specifications of the assist operation etc. The specifications of the assist operation include the action mode for the assist operation, the intensity of the assist operation, and the speed of the assist operation. Examples of the action mode include “walking,” “putting down action,” and “lifting action.” The operation unit is provided with selection buttons by which the user selects the specifications of the assist operation. The operation unit is provided in the frame 33, the jacket 22, etc. The operation unit and the controller 16 are connected to each other via wire or wirelessly and can communicate with each other. The controller 16 controls the operation of the actuator 13 (motors 40) according to information input into the operation unit.

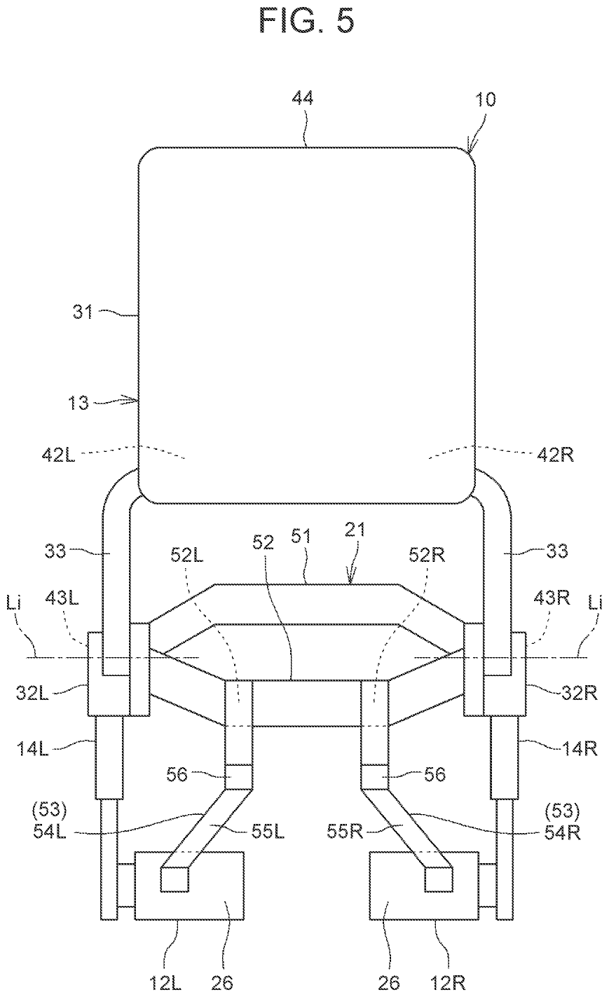

As shown in FIG. 1 and FIG. 3, the belt body 21 includes a front belt 50. The front belt 50 is provided to extend along the abdomen of the user. FIG. 5 is a back view showing a schematic configuration of the assist device 10. As shown in FIG. 3 and FIG. 5, the belt body 21 further includes an upper belt 51 and a lower belt 52. The upper belt 51 is provided on the back side of the user and extends along an upper side of the buttocks of the user. The lower belt 52 is provided on the back side of the user and extends along a lower side of the buttocks of the user.

By being located on both sides of the buttocks of the user in the up-down direction, the upper belt 51 and the lower belt 52, which work in conjunction with the front belt 50, can bring the belt body 21 into close contact with the user. The belt body 21 stabilizes the right and left activation units 32R, 32L, and thus, a desired assist force can be provided to the user by torque generated by the activation units 32R, 32L.

The assist device 10 of this embodiment further includes band-shaped restraining belts 53 that connect the second body-worn units 12R, 12L and the lower belt 52 in the up-down direction. The restraining belts 53 restrain the lower belt 52 from moving upward. In the case of the assist device 10 shown in FIG. 5, the restraining belts 53 include a left restraining belt 54L and a right restraining belt 54R. The left restraining belt 54L connects the left second body-worn unit 12L worn on the thigh of the left leg of the user to a left part 52L of the lower belt 52. The right restraining belt 54R connects the right second body-worn unit 12R worn on the thigh of the right leg of the user to a right part 52R of the lower belt 52. The left restraining belt 54L and the right restraining belt 54R are not directly connected to each other, and are provided independently of each other.

The assist device 10 shown in FIG. 5 can restrict the upward displacement of the lower belt 52 even when the user performs an action of crouching with his or her legs more than shoulder-width apart in the right-left direction and, for example, assumes a posture of hunkering down as shown in FIG. 4. As a result, an assist force by the assist device 10 can be thereafter appropriately provided to the user.

In the form shown in FIG. 5, the restraining belts 53 include the band-shaped left restraining belt 54L and the band-shaped right restraining belt 54R as described above. In this case, the left restraining belt 54L and the right restraining belt 54R function independently of each other when the user assumes a posture in which his or her right and left legs are bent differently from each other. This can enhance the function of restricting the upward displacement of the lower belt 52.

The lower belt 52 is provided so as to connect the right and left activation units 32R, 32L to each other. Therefore, the lower belt 52 can shift in the up-down direction most freely at its center in the right-left direction. To further reduce the likelihood of displacement of the center of the lower belt 52 in the right-left direction, in the form shown in FIG. 5, the left restraining belt 54L includes an inclination part 55L. The inclination part 55L is a part that extends from the left second body-worn unit 12L toward the lower belt 52 so as to incline toward the center (the right side) in the right-left direction. Similarly, the right restraining belt 54R includes an inclination part 55R. The inclination part 55R is a part that extends from the right second body-worn unit 12R toward the lower belt 52 so as to incline toward the center (the left side) in the right-left direction.

The lower belt 52 can shift in the up-down direction most freely at its center in the right-left direction as described above. However, in the configuration including the inclination parts 55L, 55R, the left restraining belt 54L and the right restraining belt 54R are connected to the lower belt 52, at positions closer to its center, which can further enhance the function of restricting the displacement of the lower belt 52. In the form shown in FIG. 5, a part of the left restraining belt 54L constitutes the inclination part 55L and a part of the right restraining belt 54R constitutes the inclination part 55R. Although this is not shown, the entire left restraining belt 54L may constitute the inclination part 55L and the entire right restraining belt 54R may constitute the inclination part 55R.

Each restraining belt 53 includes an elastic part 56 that is stretchable and shrinkable, and the elastic part 56 is provided in at least a part of the restraining belt 53. An example of the elastic part 56 is a rubber belt. In the form shown in FIG. 5, the left restraining belt 54L includes the elastic part 56 as a part thereof and the right restraining belt 54R includes the elastic part 56 as a part thereof. The elastic parts 56 allow the lengths of the left restraining belt 54L and the right restraining belt 54R to vary, and thus, the left restraining belt 54L and the right restraining belt 54R can adapt easily to a change in posture of the user to increase the comfort of wearing. In addition, neither of the left restraining belt 54L and the right restraining belt 54R hinders walking motion of the user.

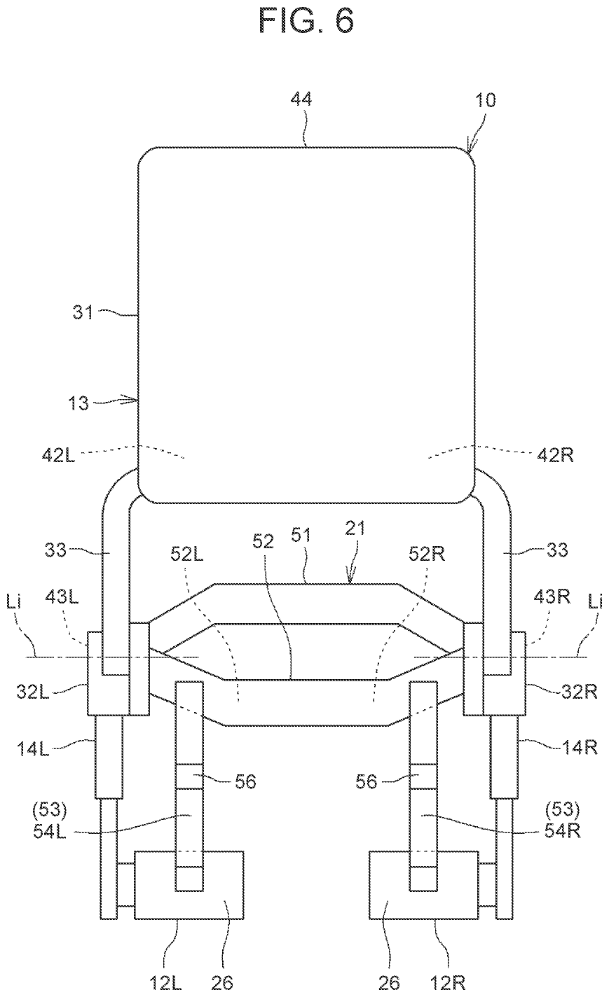

FIG. 6 is a back view showing a modified example of the restraining belts 53 shown in FIG. 5. The restraining belts 53 shown in FIG. 6 are the same as the restraining belts 53 shown in FIG. 5 in that they include the band-shaped left restraining belt 54L and the band-shaped right restraining belt 54R. The restraining belts 53 shown in FIG. 6 do not include the inclination parts 55L, 55R. Therefore, the left restraining belt 54L is connected to a left-side part of the lower belt 52 and the right restraining belt 54R is connected to a right-side part of the lower belt 52. In the case of the form shown in FIG. 6, the left restraining belt 54L and the right restraining belt 54R are likely to be hidden by the arms 14R, 14L, respectively, and thus a configuration simplified in terms of external appearance can be obtained. That is, when the user is seen from the left (or the right), the left restraining belt 54L (right restraining belt 54R) is likely to overlap the position of the arm 14L (14R) and thereby become less visible. Further, as the left restraining belt 54L and the right restraining belt 54R are located along (close to) the legs of the user, these belts are inconspicuous when the user is seen from the front side or the back side.

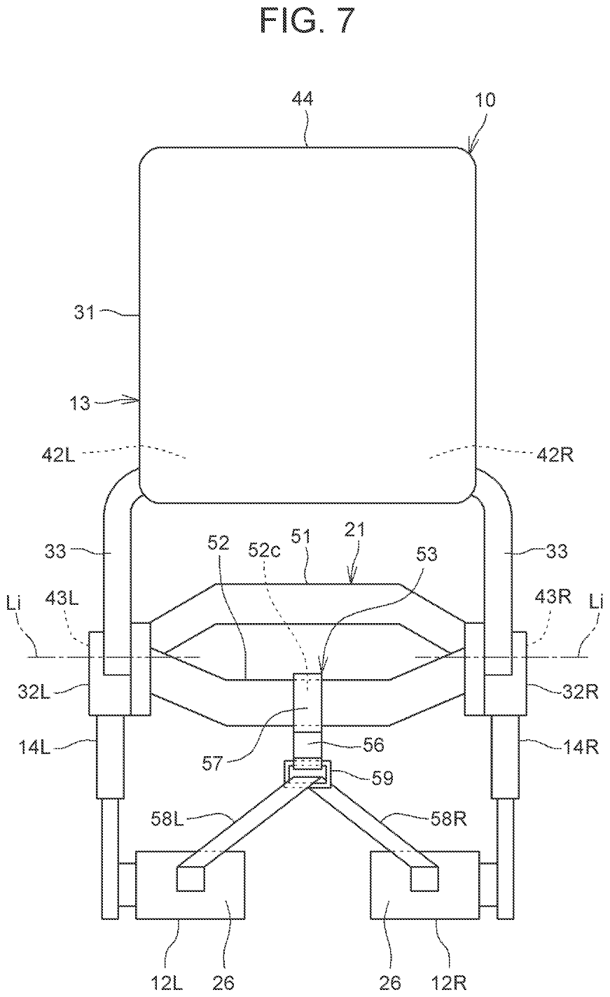

FIG. 7 is a back view showing a modified example of the restraining belts 53 shown in FIG. 5 and FIG. 6. Also in the assist device 10 shown in FIG. 7, the belt body 21 includes the upper belt 51 and the lower belt 52 in addition to the front belt 50 (not shown). The upper belt 51 is provided on the back side of the user and extends along the upper side of the buttocks of the user. The lower belt 52 is provided on the back side of the user and extends along the lower side of the buttocks of the user. The form of the belt body 21 is the same in FIG. 5 and FIG. 7.

The assist device 10 shown in FIG. 7 further includes a band-shaped restraining belt 53 that connects the second body-worn units 12R, 12L and the lower belt 52 to each other in the up-down direction. The restraining belt 53 restrains the lower belt 52 from moving upward. This is also the same in FIG. 5 and FIG. 7. In the case of the assist device 10 shown in FIG. 7, the restraining belt 53 includes a common belt part 57, a left belt part 58L, a right belt part 58R, and a coupling part 59 that connects these parts to each other.

The common belt part 57 is a band-shaped part that is connected to a central part 52c of the lower belt 52 in the right-left direction. The left belt part 58L is a band-shaped part that is connected to the left second body-worn unit 12L worn on the thigh of the left leg of the user. The right belt part 58R is a band-shaped part that is connected to the right second body-worn unit 12R worn on the thigh of the right leg of the user. The coupling part 59 is a part that couples the left belt part 58L and the right belt part 58R to the common belt part 57. In this embodiment, the coupling part 59 is formed by an annular member made of resin or metal. The common belt part 57 is attached to an upper side of the annular member, and the left belt part 58L and the right belt part 58R are attached to a lower side of the annular member.

The lower belt 52 can shift in the up-down direction most freely at its center in the right-left direction as described above. However, since the restraining belt 53 of the configuration shown in FIG. 7 includes the common belt part 57 connected to the central part 52c of the lower belt 52, it is possible to further enhance the function of restricting the displacement of the lower belt 52.

Further, in the form shown in FIG. 7, the left belt part 58L and the right belt part 58R are continuous with each other at the side of the coupling part 59. That is, the left belt part 58L and the right belt part 58R are continuous with each other and formed by a single band-shaped member. The coupling part 59 supports a continuous part (i.e., the single band-shaped member) including the left belt part 58L and the right belt part 58R that are continuous with each other in a state in which the continuous part is folded back (i.e., bent) at an intermediate point. Therefore, the continuous part including the left belt part 58L and the right belt part 58R that are continuous with each other is supported by the coupling part 59 so as to be movable in a longitudinal direction of the continuous part. The coupling part 59 has an annular shape such that the left belt part 58L and the right belt part 58R are hung on the coupling part 59 and supported by the coupling part 59.

With the restraining belt 53 having this configuration, the length of each of the left belt part 58L and the right belt part 58R can vary freely when the user assumes a posture in which his or her right and left legs are bent differently from each other. This can further enhance the function of restricting the displacement of the lower belt 52. When the user assumes a posture in which his or her right and left legs are bent differently from each other, the lengths of the left belt part 58L and the right belt part 58R may become different from each other but the total length of the left belt part 58L and the right belt part 58R remains the same. This restraining belt 53 makes it easier for the user to walk, because the lengths of the left belt part 58L and the right belt part 58R are automatically changed in accordance with the walking motion.

Also in the form shown in FIG. 7, the restraining belt 53 includes the elastic part 56 that is stretchable and shrinkable, and the elastic part 56 is provided in at least a part thereof. An example of the elastic part 56 is a rubber belt. In the form shown in FIG. 7, the common belt part 57 includes the elastic part 56 as a part thereof, but the elastic part may be provided at another part. The elastic part 56 allows the length of the common belt part 57 to vary, and thus, the restraining belt 53 as a whole can adapt easily to a change in posture of the user to increase the comfort of wearing. In addition, the restraining belt 53 does not hinder walking motion of the user.

The parts of the restraining belts 53 of the respective forms shown in FIG. 5, FIG. 6, and FIG. 7 other than the elastic parts 56 are formed by members (band-shaped members) that do not stretch or shrink. The restraining belt 53 and the second body-worn units 12R, 12L may be attached to each other by sewing, or alternatively, with the use of a touch-and-close fastener or a fastener, such as a lobster clasp, so as to be detachable from each other. Similarly, the lower belt 52 and the restraining belt 53 may be attached to each other by sewing, or alternatively, with the use of a touch-and-close fastener or a fastener, such as a lobster clasp, so as to be detachable from each other.

As has been described above, the assist devices 10 of the respective forms include the actuator 13, the first body-worn unit 11, the right and left arms 14R, 14L, and the second body-worn units 12R, 12L. The actuator 13 includes the right and left activation units 32R, 32L that generate torque around the imaginary line Li passing through the hips of the user in the right-left direction. The right and left arms 14R, 14L are swung by the torque. The first body-worn unit 11 is a body-worn unit including the belt body 21 that connects the right and left activation units 32R, 32L to each other. The actuator 13 is worn on the body of the user with the use of the first body-worn unit 11. The second body-worn units 12R, 12L are body-worn units that are attached to the distal parts of the arms 14R, 14L and worn on the thighs BF of the user.

The belt body 21 includes the upper belt 51 and the lower belt 52 that are provided on the back side of the user, and respectively extend along the upper side and the lower side of the buttocks of the user. The assist device 10 further includes the restraining belts 53, and the restraining belts 53 connect the second body-worn units 12R, 12L and the lower belt 52 to each other and function to restrain the lower belt 52 from moving upward.

The assist device 10 having this configuration can restrict the upward displacement of the lower belt 52 of the belt body 21 even when, for example, the user assumes a posture of hunkering down as shown in FIG. 4. Meanwhile, the upper belt 51 and the front belt 50 are hardly affected by the posture of the user and therefore do not become displaced. As a result, an assist force by the assist device 10 can be thereafter appropriately provided to the user. Thus, it is possible to restrict the displacement of the belt body 21 and to provide the user with a desired assist force regardless of the posture of the user.

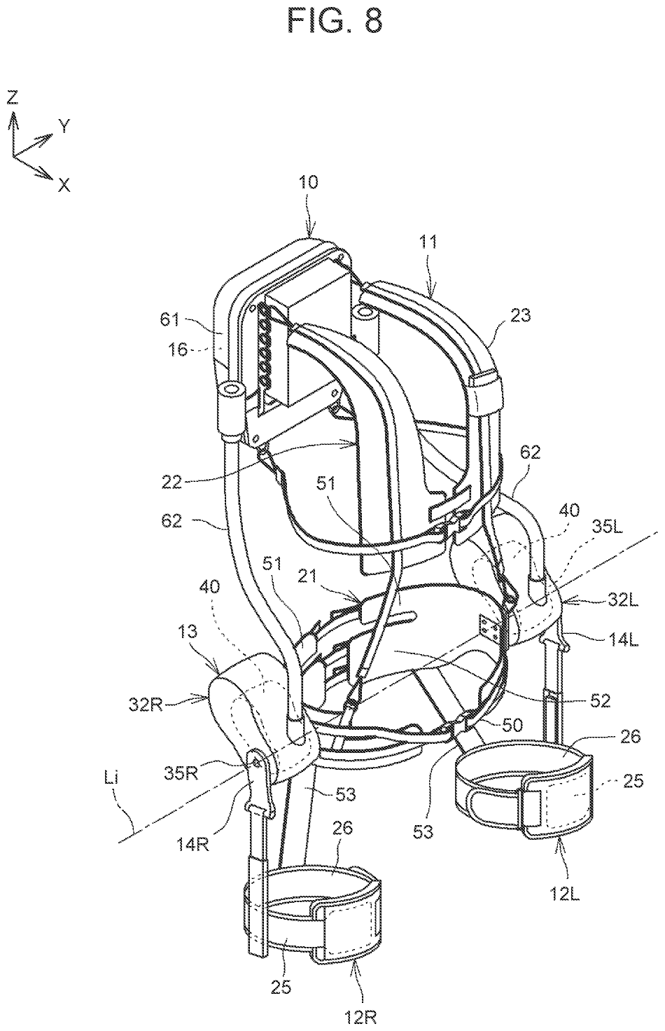

The first body-worn unit 11, the second body-worn units 12R, 12L, the actuator 13, the arms 14R, 14L, and the restraining belts 53 may have forms different from those shown in the drawings. FIG. 8 is a perspective view showing a modified example of the assist device 10. The actuator 13 shown in FIG. 8 includes the right and left activation units 32R, 32L that generate torque around the imaginary line Li passing through the hips of the user in the right-left direction. The activation units 32R, 32L are worn on the right and left sides of the hips of the user with the use of the belt body 21. This is the same as in the assist device 10 shown in FIG. 1.

In the form shown in FIG. 8, the motor 40 that causes the output shaft 35L (35R) of the activation unit 32L (32R) to generate torque is provided in the activation unit 32L (32R). A speed reducer formed by a gear mechanism that reduces the speed of rotation of the motor 40 is provided in the activation unit 32L (32R), and the arm 14L (14R) is attached to the output shaft 35L (35R) of the speed reducer. The actuator 13 further includes a backpack 61 that is carried on the back of the user, and high-rigidity frames 62 that couple the backpack 61 and the right and left activation units 32R, 32L together. A battery that supplies electricity to the motors 40 etc., and the controller 16 are housed in the backpack 61.

The belt body 21 shown in FIG. 8 includes the upper belt 51 and the lower belt 52 that are provided on the back side of the user, in addition to the front belt 50. The upper belt 51 extends along the upper side of the buttocks of the user. The lower belt 52 extends along the lower side of the buttocks. The assist device 10 includes the restraining belts 53, and the restraining belts 53 connect the second body-worn units 12R, 12L and the lower belt 52 to each other and thereby restrain the lower belt 52 from moving upward. As the restraining belts 53, one of the forms shown in FIG. 5, FIG. 6, and FIG. 7 is adopted. The assist device 10 shown in FIG. 8 can also restrict the displacement of the lower belt 52 and provide the user with a desired assist force.

The embodiment disclosed this time is in every respect illustrative and not restrictive. The scope of the disclosure is not limited to the above embodiment, and includes all changes within a scope equivalent to the configuration described in the claims.

What is claimed is:

1. An assist device comprising:
an actuator including right and left activation units that are configured to generate torque around an imaginary line passing through hips of a user in a right-left direction;
a first body-worn unit including a belt body that connects the right and left activation units to each other, the actuator being worn on a body of the user with use of the first body-worn unit;
right and left arms that are swung by the torque; and
second body-worn units that are attached to distal parts of the arms and worn on thighs of the user, wherein:
the belt body includes an upper belt and a lower belt provided on a back side of the user, the upper belt and the lower belt respectively extending along an upper side and a lower side of buttocks of the user; and
the assist device includes a restraining belt that connects the second body-worn units to the lower belt and restrains the lower belt from moving upward.

2. The assist device according to claim 1, wherein the restraining belt includes a left restraining belt that connects a left second body-worn unit of the second body-worn units to the lower belt, and a right restraining belt that connects a right second body-worn unit of the second body-worn units to the lower belt, the left second body-worn unit being worn on the thigh of a left leg of the user, and the right second body-worn unit being worn on the thigh of a right leg of the user.

3. The assist device according to claim 2, wherein:
the left restraining belt includes an inclination part that extends from the left second body-worn unit toward the lower belt so as to incline toward a center in the right-left direction; and
the right restraining belt includes an inclination part that extends from the right second body-worn unit toward the lower belt so as to incline toward the center in the right-left direction.

4. The assist device according to claim 1, wherein the restraining belt includes:
a common belt part that is connected to a central part of the lower belt in the right-left direction;
a left belt part that is connected to a left second body-worn unit of the second body-worn units, the left second body-worn unit being worn on the thigh of a left leg of the user;
a right belt part that is connected to a right second body-worn unit of the second body-worn units, the right second body-worn unit being worn on the thigh of a right leg of the user; and
a coupling part that couples the left belt part and the right belt part to the common belt part.

5. The assist device according to claim 4, wherein:
the left belt part and the right belt part are continuous with each other; and
the coupling part supports a continuous part including the left belt part and the right belt part that are continuous with each other in a state in which the continuous part is folded back at an intermediate point, so as to allow the continuous part to move in a longitudinal direction of the continuous part.

6. The assist device according to claim 1, wherein the restraining belt includes an elastic part that is stretchable and shrinkable, the elastic part being provided in at least a part of the restraining belt.
